(19) United States
(12) Patent Application Publication
(10) Pub. No.: US 2014/0174138 A1
(43) Pub. Date: Jun. 26, 2014

(54) LOCK SYSTEM AND METHOD FOR OPENING

(71) Applicant: HON HAI PRECISION INDUSTRY CO., LTD., New Taipei (TW)

(72) Inventor: YI-ZHONG SHEU, New Taipei (TW)

(21) Appl. No.: 13/926,103

(22) Filed: Jun. 25, 2013

(30) Foreign Application Priority Data
Dec. 21, 2012 (TW) 101148935

(51) Int. Cl. E05B 17/14

(52) U.S. Cl. CPC E05B 17/147
USPC 70/344

(57) ABSTRACT

A lock system includes a lock, a key and a cover. The lock has a key hole defined therein. The key has a signal projector fixed thereon. The signal projector is capable of emitting a signal with a predetermined code. The cover shelters on the key hole and a signal receiver is fixed on the cover. The signal receiver is configured for receiving the signal emitted by the signal projector, and moved to expose the key hole when determining the signal emitted by the signal projector with a matched code. The present discloser also provides a method for opening the lock system.

### BACKGROUND

1. Technical Field

The disclosure relates to lock systems and methods for opening the same, and particularly to a lock system using an optical sensor and a method for opening the same.

2. Description of the Related Art

A door is necessary for every house. A door lock is fixed on the door for safety. A conventional door lock defines a key hole. The door lock can be open when a right key is inserted into the key hole and turned an angle.

However, the door lock with the key hole is not safe enough. A trained person can open the door lock with special tools, which will cause potential security problems.

Therefore, it is desirable to provide a lock system and a method for opening the same which can overcome the above shortcomings.

### BRIEF DESCRIPTION OF THE DRAWINGS

Many aspects of the disclosure can be better understood with reference to the drawings. The components in the drawings are not necessarily drawn to scale, the emphasis instead being placed upon clearly illustrating the principles of the present lock system and a method for opening it. Moreover, in the drawings, like reference numerals designate corresponding parts throughout the views.

FIG. 1 is an abridged general view of a locked lock system in accordance with an embodiment of the present disclosure, wherein the lock system is fixed on a door.

FIG. 2 is similar to FIG. 1, showing the lock system being open.

FIG. 3 is a flow chart of a method for opening the lock system of FIG. 1.

### DETAILED DESCRIPTION

Reference will now be made to the drawings to describe the present lock system, and a method for opening the lock system, in detail.

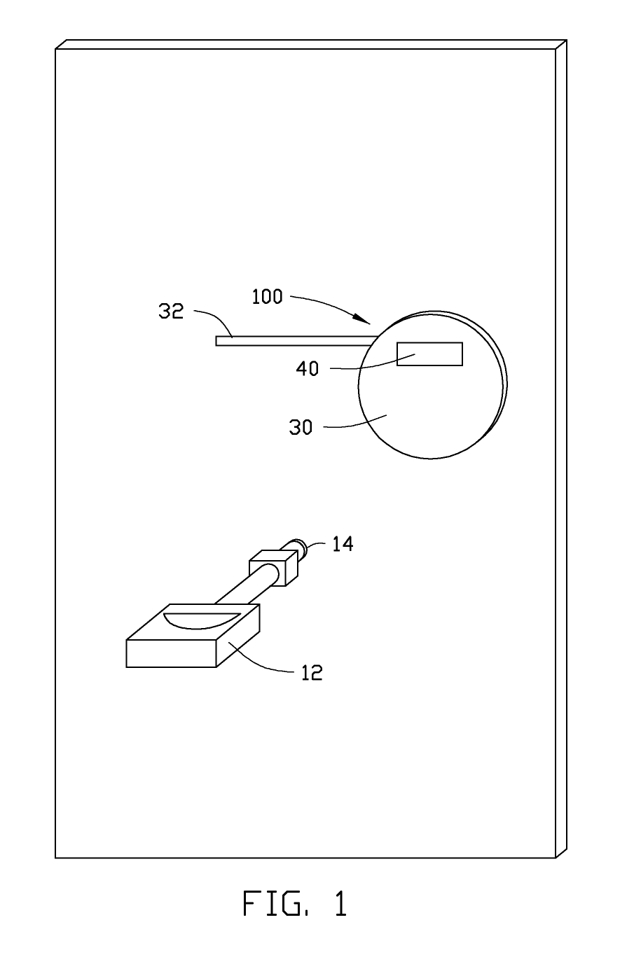

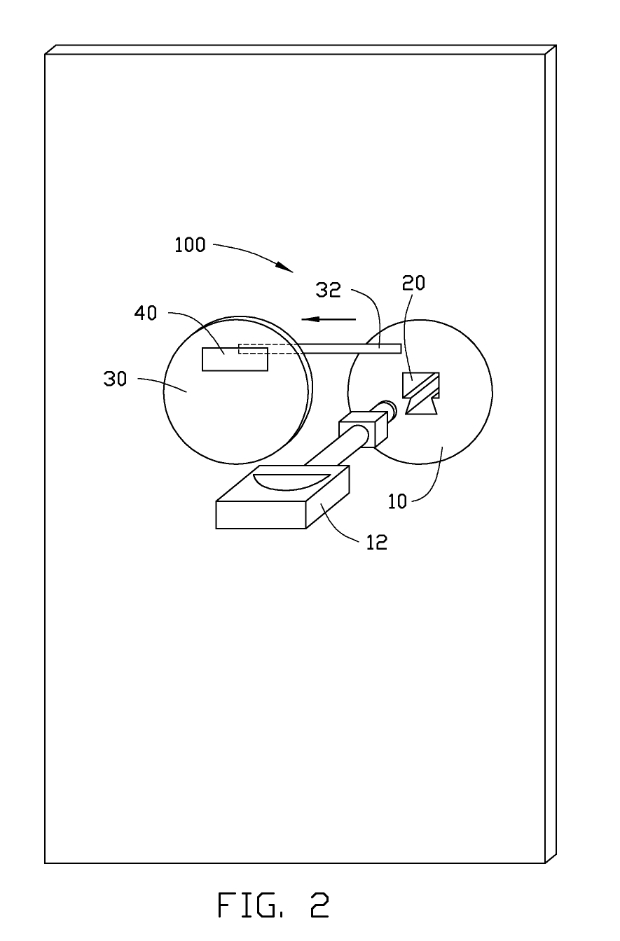

Referring to FIGS. 1-2, a lock system 100 includes a lock 10 and a key 12 which is used for opening the lock 10. A key hole 20 is defined in the lock 10. The key 12 is inserted into the key hole 20 and turned a predetermined angle in order to open the lock 10 of the lock system 100. In the embodiment, the lock 10 can be a door lock.

A signal projector 14 is fixed on a distal end of the key 12. In the embodiment, the signal projector 14 is a light source, preferably, an LED (light emitting diode). The light source generates a light signal representing a predetermined code to open the lock 10. The light signal is a pulse signal. The pulse signal has specific pulse width, pulse interval or/and pulse frequency. The predetermined code is associated with the pulse width, pulse interval, pulse frequency of the pulse signal or any combination thereof. The key 12 further includes a driving unit (not illustrated) to control the signal projector 14 to generate the light signal.

A cover 30 is mounted on the lock 10 to shelter the key hole 20. When the lock system 100 is locked, the cover 30 shelters the key hole 20 to prevent the key hole 20 from exposing outside. Therefore, any other keys or other tools can't insert into the key hole 20.

A signal receiver 40 is fixed on the cover 30 for receiving the light signal generated by the signal projector 14. In the embodiment, the signal receiver 40 is a light sensor corresponding to the light source. The signal receiver 40 receives the light signal and determines whether the code of the light signal matches a predetermined value, such as specific pulse width, pulse interval or/and pulse frequency. If the code of the light signal matches the predetermined value, the signal receiver 40 controls the cover 30 to move away from the key hole 20 until the key hole is exposed. If the code of the light signal does not match the predetermined value, the signal receiver 40 will refuse the key 12 and may alarm.

When the lock system 100 needs to be open, the distal end of the key 12 is positioned at the light sensor on the cover 30, the light source is controlled to generate a light signal. The light signal is received by the light sensor. The cover 30 moves to expose the key hole 20. Then, the key 12 is able to insert into the key hole 20 and turned an angle to open the lock 10.

The cover 30 of the lock system 100 can be assembled to a location of the door corresponding to the key hole 20 rotatably or slidably. The cover 30 further connects a driving portion (not illustrated). The light sensor sends a control signal to the driving portion when receives a predetermined signal. The driving portion drives the cover 30 to rotate or slide. In the embodiment, the cover 30 moves away from the key hole 20 slidably via a rail 32. A distance which the cover 30 moves can be pre-set in the driving portion.

When the lock system 30 is open, the driving portion receives a resetting signal to control the cover 30 to move back to cover the key hole 20.

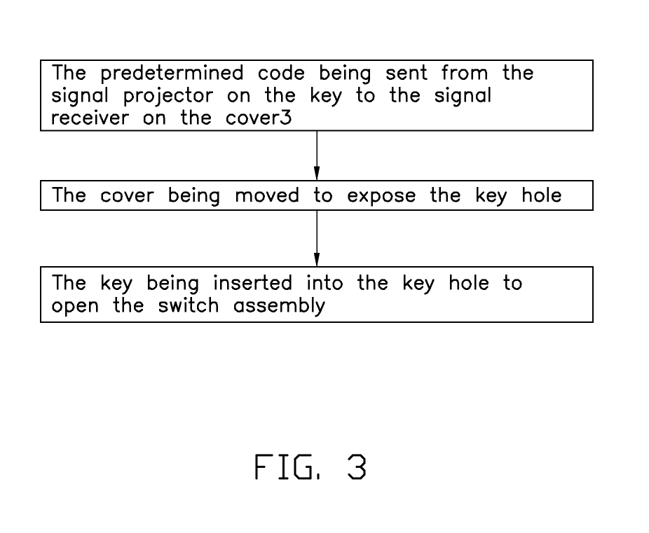

FIG. 3 shows a flow chart of a method for opening the lock system 100. The method includes steps of:
Step 1: the predetermined code being sent from the signal projector 14 on the key 12 to the signal receiver 40 on the cover 30;
Step 2: the cover 30 moving to expose the key hole 20; and
Step 3: the key 12 being inserted into the key hole 20 to open the lock system 100.

It is to be understood that the above-described embodiments are intended to illustrate rather than limit the disclosure. Variations may be made to the embodiments without departing from the spirit of the disclosure as claimed. The above-described embodiments illustrate the scope of the disclosure but do not restrict the scope of the disclosure.

1. A lock system, comprising:
a lock with a key hole defined in the lock;
a key with a signal projector fixed on the key, the signal projector capable of emitting a signal with a predetermined code;
a cover sheltering on the key hole; and
a signal receiver fixed on the cover, the signal receiver configured for receiving the signal emitted by the signal projector, when the signal emitted by the signal projector matches a matched code, the signal receiver controls the cover to move away from the key hole until the key hole is exposed.

2. The lock system of claim 1, wherein the signal projector is a light source, and the light source generates a light signal representing the predetermined code to open the lock.

3. The lock system of claim 2, wherein the light source is an LED.

4. The lock system of claim 2, wherein the light signal is a pulse signal, and the pulse signal has specific pulse width, pulse interval or/and pulse frequency.

5. The lock system of claim 4, wherein the predetermined code is associated with the pulse width, pulse interval, pulse frequency of the pulse signal or any combination thereof.

6. The lock system of claim 2, wherein the signal receiver is a light sensor corresponding to the light source.

7. The lock system of claim 1, wherein the signal projector is fixed on a distal end of the key.

8. The lock system of claim 1, wherein the cover moves away from the key hole slidably via a rail.

9. A method for opening the lock system of claim 1 comprising steps:
sending the predetermined code from the signal projector on the key to the signal receiver on the cover;
moving the cover to expose the key hole; and
inserting the key into the key hole to open the lock system.
